(19) United States
(12) Patent Application Publication
(10) Pub. No.: US 2022/0261826 A1
(43) Pub. Date: Aug. 18, 2022

(54) INFORMATION DELIVERY SYSTEM AND METHOD FOR INFORMATION DELIVERY

(71) Applicant: HONDA MOTOR CO., LTD., Tokyo (JP)

(72) Inventors: Tomohide Haraguchi, Wako-shi, Saitama (JP); Ryo Nakayama, Wako-shi, Saitama (JP)

(21) Appl. No.: 17/619,104

(22) PCT Filed: Jun. 24, 2019
(86) PCT No.: PCT/JP2019/024995

§ 371 Date: Dec. 14, 2021

(51) Int. Cl. G06Q 30/02; G06Q 50/30

(52) U.S. Cl. CPC G06Q 30/0205; G06Q 30/0206; G06Q 50/30

(57) ABSTRACT

A use information acquisition unit acquires information on the use of renewable energy by the user. A user information acquisition unit acquires user information including information about the evaluation of the user. The social rating determination unit determines the social rating of the user based on the information on the use of renewable energy and the user information. The social rating information output unit outputs social rating information including the social rating of the user determined by the social rating determination unit.

### TECHNICAL FIELD

The present invention relates to an information delivery system and a method for information delivery.

### BACKGROUND ART

In a proposed configuration for a conventional carbon dioxide emission permit transaction system, when a transaction is established between a biomass fuel distributor and another dealer, at least a part of the fee for the carbon dioxide emission permit is returned to the biomass fuel purchaser as a point corresponding to the amount of biomass fuel purchased (see Patent Literature 1, for example).

In addition, in a proposed configuration for a navigation device, it is determined based on the position of the vehicle and crime information whether the current location is in a safe area (see Patent Literature 2, for example).

### CITATION LIST

### Patent Literature

Patent Literature 1: JP 2004-206705 A

Patent Literature 2: JP 2009-276121 A

### SUMMARY OF INVENTION

### Technical Problem

In the transaction system described in Patent Literature 1, information on the amount of biomass fuel purchased is used for returning a part of the transaction fee for the carbon dioxide emission permit, but it is conceivable to use the information for other purposes such as determining the safety of the area, like the navigation device described in Patent Literature 2 does, for example.

The present invention has been made in view of such a background, and an object thereof is to provide an information delivery system and a method for information delivery that enable delivery of useful information based on information on the use of renewable energy such as biomass fuel.

### Solution to Problem

A first aspect for achieving the above object is an information delivery system including: a use information acquisition unit that acquires information on use of renewable energy by a user; a user information acquisition unit that acquires user information including information about evaluation of the user; a social rating determination unit that determines a social rating of the user based on the information on use and the user information; and a social rating information output unit that outputs social rating information including the social rating of the user determined by the social rating determination unit.

Here, the social rating is an evaluation of whether the user to be evaluated is a valuable entity in a region, a society, or the world: the higher the existence value of the user, the higher the user's social rating. Elements that affect the social rating include the degree of contribution to the society, which is exemplified by awareness of environmental burdens. In addition, the credibility of the user may be adopted as the social rating. Credibility is a measure for quantitatively evaluating whether the user is a reliable person.

The information delivery system may include: an energy supply point recognition unit that recognizes an energy supply point that is a point where the renewable energy is supplied to the user; an area rating determination unit that determines an area rating of a predetermined area including the energy supply point based on the social rating of the user determined by the social rating determination unit; and an area rating information output unit that outputs area rating information including the area rating of the predetermined area determined by the area rating determination unit.

Here, the area rating is an evaluation of whether a predetermined area to be evaluated is an area having social value. Specific elements that affect the area rating include livability, security, implementation status of social contribution activities, and the like. In addition, the degree of safety of the area may be adopted as the area rating.

The information delivery system may include: a residence place recognition unit that recognizes a place of residence of the user; an area rating determination unit that determines an area rating of a predetermined area including the place of residence based on the social rating of the user determined by the social rating determination unit; and an area rating information output unit that outputs area rating information including the area rating of the predetermined area determined by the area rating determination unit.

The information delivery system may include a crime occurrence information acquisition unit that acquires crime occurrence information in the predetermined area, and the area rating determination unit may be configured to determine the area rating of the predetermined area based on the crime occurrence information.

In the information delivery system, the area rating information output unit may be configured to transmit the area rating information to a communication device of a renewable energy supply facility located in the predetermined area, and the area rating determination unit may be configured to, when receiving security enhancement information related to the renewable energy supply facility from the communication device of the renewable energy supply facility, update the area rating of the predetermined area based on the security enhancement information.

The information delivery system may include a route determination unit that acquires setting information of a destination, and determines a route from a predetermined place of departure to the destination with reference to the area rating of the predetermined area determined by the area rating determination unit.

The information delivery system may include a ride-sharing vehicle dispatch unit that acquires ride-sharing vehicle request information for requesting dispatch of a ride-sharing vehicle, and executes a process of dispatching a ride-sharing vehicle to invite a requester who has requested dispatch of a ride-sharing vehicle using the ride-sharing vehicle request information to get in a ride-sharing vehicle in the predetermined area having an area rating determined by the area rating determination unit equal to or higher than a predetermined level.

The information delivery system may include a ride-sharing vehicle dispatch unit that acquires ride-sharing vehicle request information for requesting dispatch of a ride-sharing vehicle, and executes a process of distinctively dispatching a ride-sharing vehicle that uses renewable energy and a ride-sharing vehicle that uses energy other than renewable energy to dispatch a ride-sharing vehicle that uses renewable energy to the user whose social rating determined by the social rating determination unit is high in preference to the user whose social rating determined by the social rating determination unit is low.

In the information delivery system, the information on use of renewable energy may be information on supply of biomass fuel to the user.

The information delivery system may include a first charge amount setting unit that sets, for provision of a first service that uses the area rating of the predetermined area determined by the area rating determination unit, a first charge amount that depends on what the first service offers.

Here, the first service that uses the area rating includes delivery of information on the area rating of the predetermined area, guidance on the route to the destination determined with reference to the area rating, guidance to the riding point for a ride-sharing vehicle determined with reference to the area rating, and the like.

The information delivery system may include a second charge amount setting unit that sets a second charge amount for an administrator of a rating-output area or a facility in the rating-output area in accordance with a level of the area rating of the rating-output area, the rating-output area being the predetermined area for which the area rating has been determined by the area rating determination unit and the area rating information has been output by the area rating information output unit.

In the information delivery system, the area rating determination unit may be configured to, when receiving first redetermination request information for requesting redetermination of the area rating from an administrator of a rated area or a communication device of a facility in the rated area, the rated area being the predetermined area that has been given the area rating, redetermine the area rating of the rated area only after a first redetermination cost is received.

The information delivery system may include a third charge amount setting unit that sets, for provision of a second service that uses the social rating of the user determined by the social rating determination unit, a third charge amount that depends on what the second service offers.

Here, the second service that uses the social rating includes delivery of information on the social rating of the user, delivery of information on the dispatch of a ride-sharing vehicle determined with reference to the social rating, and the like.

The information delivery system may include a fourth charge amount setting unit that sets a fourth charge amount for a rating-output user in accordance with a level of the social rating of the rating-output user, the rating-output user being the user for which the social rating has been determined by the social rating determination unit and the social rating information has been output by the social rating information output unit.

In the information delivery system, the social rating determination unit may be configured to, when receiving second redetermination request information for requesting redetermination of the social rating from a communication device of a rated user, the rated user being the user who has been given the social rating, redetermine the social rating of the rated user only after a second redetermination cost is received.

A second aspect for achieving the above object is an information delivery system including: a use information acquisition unit that executes a use information acquisition process of acquiring information on use of renewable energy by a user; a user information acquisition unit that executes a user information acquisition process of acquiring user information including information about evaluation of the user; a social rating determination unit that determines a social rating of the user based on the information on use and the user information; and a social rating information output unit that executes a social rating information output process of outputting social rating information including the social rating of the user determined by the social rating determination unit.

A third aspect for achieving the above object is a method for information delivery that is executed by a computer, the method including: a use information acquisition step of acquiring information on use of renewable energy by a user; a user information acquisition step of acquiring user information including information about evaluation of the user; a social rating determination step of determining a social rating of the user based on the information on use and the user information; and a social rating information output step of outputting social rating information including the social rating of the user determined in the social rating determination step.

### Advantageous Effects of Invention

According to the information delivery system, the social rating determination unit determines the social rating of the user based on information on the use of renewable energy by the user and user information including information about the evaluation of the user. Here, because renewable energy produces lower carbon dioxide emissions than fossil fuel, it is estimated that users of renewable energy are highly aware of environmental burdens. Then, users who are highly aware of environmental burdens can be regarded as having high social morals. Therefore, by using information on the use of renewable energy together with user information, the social rating of the user is expected to be more objectively determined.

Then, by outputting social rating information from the social rating information output unit, it is possible to deliver useful information based on information on the use of renewable energy.

### BRIEF DESCRIPTION OF DRAWINGS

FIG. 1 is an explanatory diagram illustrating an aspect of information delivery by an information delivery system.

FIG. 2 is a configuration diagram illustrating the information delivery system.

FIG. 3 is an explanatory diagram illustrating a user database.

FIG. 4 is an explanatory diagram illustrating an area rating database.

FIG. 5 is a flowchart illustrating a process of determining the social rating of a user.

FIG. 6 is a flowchart illustrating a process of determining an area rating.

### DESCRIPTION OF EMBODIMENTS

[1. Aspect of Information Delivery by Information Delivery System]

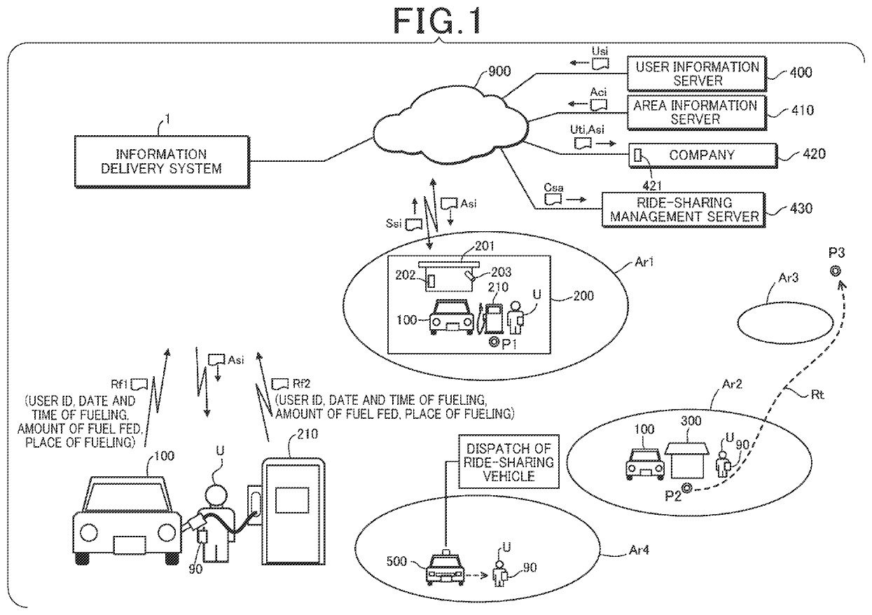

An aspect of information delivery by an information delivery system 1 according to the present embodiment will be described with reference to FIG. 1. The information delivery system 1 executes, for a user U registered in the information delivery system 1, a process of determining the social rating of the user U in accordance with information on the use of biomass ethanol (corresponding to renewable energy) by the user U. The information delivery system 1 also executes a process of determining the area ratings of an area Ar1 and an area Ar2. The area Ar1 includes a point P1 where the user U has filled a vehicle 100 with biomass ethanol. The area Ar2 includes the location of a home 300 of the user U (place of residence of the user U). The areas Ar1 and Ar2 correspond to a predetermined area according to the present invention.

The information delivery system 1 communicates via a communication network 900 with the vehicle 100, a fueling device 210 that supplies biomass ethanol, a user terminal 90 used by the user, a communication terminal 202 provided in a fueling facility 200 (corresponding to a renewable energy supply facility) including the fueling device 210 that supplies biomass ethanol and a store 201, a user information server 400, an area information server 410, a communication terminal 421 provided in a company 420, and a ride-sharing management server 430.

The information delivery system 1 recognizes that the user U has filled the vehicle 100 with biomass ethanol by receiving first fueling information Rf1 transmitted from the vehicle 100 filled with biomass ethanol or second fueling information Rf2 transmitted from the fueling device 210 that has supplied biomass ethanol to the vehicle 100.

The information delivery system 1 receives rating information Usi of the user U from the user information server 400. The information delivery system 1 also receives crime occurrence information Aci of the areas Ar1 and Ar2 from the area information server 410. The information delivery system 1 further requests the dispatch of a ride-sharing vehicle by transmitting ride-sharing request information Csa to the ride-sharing management server 430, which manages the dispatch of ride-sharing vehicles.

The information delivery system 1 determines the social rating of the user U based on the number of times of biomass ethanol filling and the rating information Usi, and determines the area ratings of the areas Ar1 and Ar2 based on the social rating of the user U and the crime information of the areas Ar1 and Ar2.

The information delivery system 1 then executes the following processes (1-1) to (1-5) with respect to the social rating of the user U and the area ratings of the areas Ar1 and Ar2.

(1-1) Delivery of social rating information Uti including the social rating of the user U. As an aspect of delivery of the social rating information Uti, FIG. 1 depicts an exemplary case where the social rating information Uti is transmitted from the information delivery system 1 to the communication terminal 421 of the company 420.

(1-2) Delivery of area rating information Asi including the area ratings. As an aspect of delivery of the area rating information Asi, FIG. 1 depicts an exemplary case where the area rating information Asi is transmitted from the information delivery system 1 to the communication terminal 421 of the company 420, the user terminal 90, and the communication terminal 202 provided in the fueling facility 200.

(1-3) Receipt of a consideration corresponding to the delivery of the social rating information Uti or the area rating information Asi and management of a part of the consideration. FIG. 1 depicts an exemplary case where a part of the consideration for the information delivery is applied for improving the security equipment of the fueling facility 200 such as a security camera 203, and accordingly, security enhancement information Ssi indicating that the security measures in the fueling facility 200 have been enhanced is transmitted from the communication terminal 202 of the fueling facility to the information delivery system 1.

(1-4) Dispatch of a ride-sharing vehicle using the area ratings and the social rating of the user U. FIG. 1 depicts an exemplary case where the ride-sharing request information Csa for requesting the dispatch of a ride-sharing vehicle 500 is transmitted to the ride-sharing management server 430 in response to a request from the user U. The information delivery system 1 requests the ride-sharing management server 430 to invite the user U to get in a ride-sharing vehicle in an area having an area rating equal to or higher than a predetermined level. The information delivery system 1 also requests the ride-sharing management server 430 to dispatch a ride-sharing vehicle that uses biomass ethanol preferentially to the user U whose social rating is high.

(1-5) Determination of a route to a destination using the area ratings. FIG. 1 depicts an exemplary case where when the information delivery system 1 receives, from the user terminal 90 of the user U in the area Ar2, information for requesting a route search from a location P2 of the home 300 of the user U as a start point to a destination P3, the information delivery system 1 determines a route Rt that avoids an area Ar3 having a low area rating (low safety).

[2. Configuration of Information Delivery System]

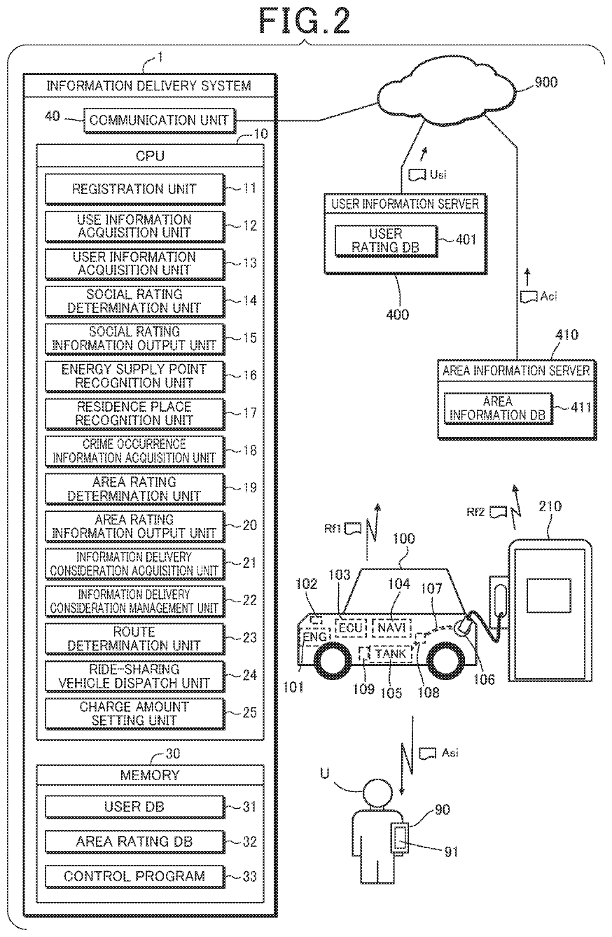

The configuration of the information delivery system 1 will be described with reference to FIGS. 2 to 4. FIG. 2 illustrates the configuration of the information delivery system 1 and the configurations of the vehicle 100, the user information server 400, and the area information server 410 conforming to the situation illustrated in FIG. 1.

The vehicle 100 includes an engine 101 that is an internal combustion engine, a communication unit 102, an electronic control unit (ECU) 103, a navigation unit 104, a fuel tank 105, a fueling path 107 connecting a filler opening 106 and the fuel tank 105, an ethanol sensor 108 provided in the middle of the fueling path 107, and a remaining amount sensor 109 that detects the amount of fuel remaining in the fuel tank 105. The vehicle 100 can use gasoline or ethanol as fuel.

The ECU 103 includes a CPU, a memory, and the like (not illustrated), and controls the operation of the vehicle 100. The navigation unit 104 includes map data and a global positioning system (GPS) sensor that detects the current location of the vehicle 100, so as to provide route guidance to the destination. The ethanol sensor 108 detects that the fuel being supplied is ethanol based on the dielectric constant of the fuel flowing through the fueling path 107. The remaining amount sensor 109 detects the amount of fuel remaining in the fuel tank 105.

When fuel is supplied from the fueling device 210 to the vehicle 100, the ECU 103 identifies the type of fuel being supplied from the fueling device 210 based on a detection signal from the ethanol sensor 108 and communication with the fueling device 210. The ECU 103 determines whether the fuel being supplied is ethanol or gasoline based on a detection signal from the ethanol sensor 108. When ethanol is being supplied, the ECU 103 receives fuel type information transmitted from the fueling device 210, and determines whether the ethanol being supplied is biomass ethanol or synthetic ethanol.

In response to determining that the ethanol being supplied is biomass ethanol, the ECU 103 transmits, to the information delivery system 1, the first fueling information Rf1 including the user identification (ID), i.e. identification information of the user U, the date and time of fueling, the amount of fuel fed, and the place of fueling. As will be described later, the user ID is issued by the information delivery system 1 and stored in the memory of the ECU 103 and the user terminal 90. The place of fueling is the current location of the vehicle 100 detected by the navigation unit 104. Note that the second fueling information Rf2 including the user ID and the amount of fuel fed may be transmitted from the fueling device 210 to the information delivery system 1. In this case, the fueling device 210 receives the user ID through communication with the ECU 103 of the vehicle 100 or the user terminal 90, and the place of fueling is the installation position of the fueling device 210.

The user information server 400 includes a user rating database (DB) 401. Various kinds of rating information about the user U are recorded in the user rating DB 401. The rating information about the user U recorded includes the rating of the user U in a social networking service (SNS), the crime history of the user U, the history of social service activities of the user U, and the like. The area information server 410 includes an area information DB 411. The area information DB 411 records the number of crime occurrences, the frequency of crime occurrences, details of crimes, and the like for each of the predetermined areas Ar1 to Ar3 illustrated in FIG. 1.

The information delivery system is a computer system including a central processing unit (CPU) 10, a memory 30, a communication unit 40, and the like. The memory 30 stores a control program 33 for the information delivery system 1 in addition to the user DB 31 and the area rating DB 32.

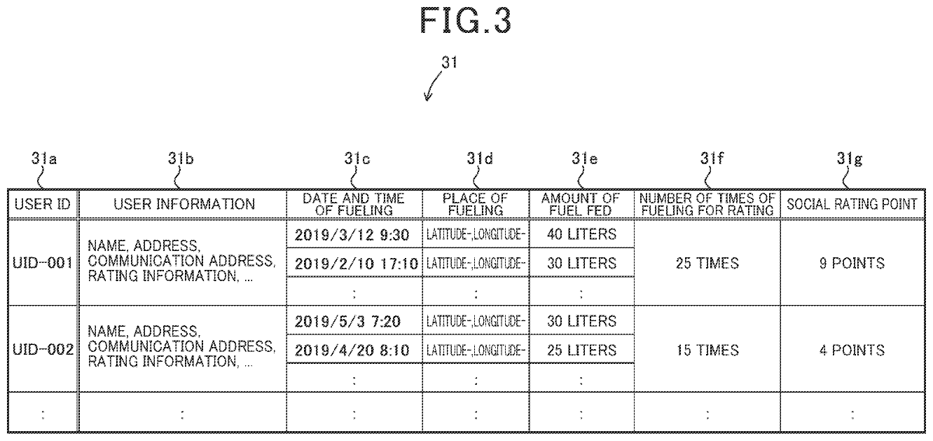

As illustrated in FIG. 3, the user DB 31 records, for each user registered in the information delivery system 1, the items: user ID 31a, user information 31b, date and time of fueling 31c, place of fueling 31d, amount of fuel fed 31e, number of times of fueling for rating 31f, and social rating point 31g. The user ID 31a is the identification information of the user issued by the information delivery system 1. The user information 31b is a record of the name, address, communication address, rating information, and the like of the user. The date and time of fueling 31c is a record of the date and time the user filled their vehicle with biomass ethanol.

The place of fueling 31d is a record of the place where the user filled their vehicle with biomass ethanol (location of the fueling facility). The amount of fuel fed 31e is a record of the amount of biomass ethanol fed. The number of times of fueling for rating 31f is a record of the number of times of biomass ethanol filling over an evaluation period (e.g. past one year) for determining the social rating of the user U. The social rating point 31g is a record of the social rating point of the user U determined on a scale of 1 to 10 based on the rating information of the user U and the number of times of fueling for rating 31f. The higher the social rating of the user U, the higher the social rating point set.

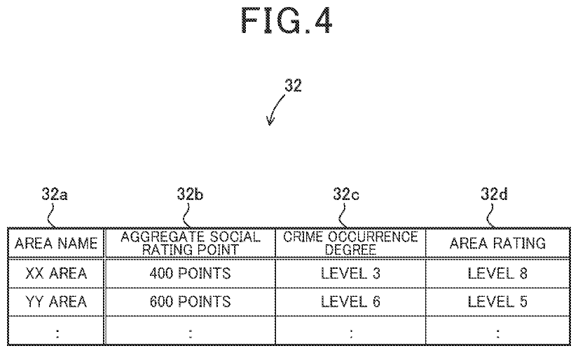

As illustrated in FIG. 4, the area rating DB 32 records, for each area to be given an area rating, the items: area name 32a, aggregate social rating point 32b, crime occurrence degree 32c, and area rating 32d. The area name 32a is a record of the name of the area (name of the administrative district or the like). The aggregate social rating point 32b is a record, over the evaluation period, of the total of the social rating points of all the users U who filled their vehicles with biomass ethanol in the area or the total of the social rating points of all the users U who live in the area. The crime occurrence degree 32c is a record of the crime occurrence degree in each area. The larger the number of crime occurrences; the higher the crime occurrence rate; and the higher the crime heinousness, the higher the crime occurrence degree of each area determined. The area rating 32d is a record of the area rating of each area determined based on the aggregate social rating point 32b and the crime occurrence degree 32c.

The CPU 10 reads and executes the control program stored in the memory 30 to function as a registration unit 11, a use information acquisition unit 12, a user information acquisition unit 13, a social rating determination unit 14, a social rating information output unit 15, an energy supply point recognition unit 16, a residence place recognition unit 17, a crime occurrence information acquisition unit 18, an area rating determination unit 19, an area rating information output unit 20, an information delivery consideration acquisition unit 21, an information delivery consideration management unit 22, a route determination unit 23, a ride-sharing vehicle dispatch unit 24, and a charge amount setting unit 25. The charge amount setting unit 25 includes the configurations of a first charge amount setting unit, a second charge amount setting unit, a third charge amount setting unit, and a fourth charge amount setting unit according to the present invention. Hereinafter, the function of each of the units 11 to 25 in the situation illustrated in FIG. 1 will be described.

The process executed by the use information acquisition unit 12 corresponds to a use information acquisition process and also corresponds to a use information acquisition step in a method for information delivery according to the present invention. The process executed by the user information acquisition unit 13 corresponds to a user information acquisition process and also corresponds to a user information acquisition step in a method for information delivery according to the present invention. The process by the social rating determination unit 14 corresponds to a social rating determination process and also corresponds to a social rating determination step in a method for information delivery according to the present invention. The process executed by the social rating information output unit 15 corresponds to a social rating information output process and also corresponds to a social rating information output step in a method for information delivery according to the present invention.

In response to an application by the user U, the registration unit 11 executes a user registration process of recording, in the user DB 31, personal information such as the name and address of the user U for registration with the information delivery system 1. The application for registration of the user U with the information delivery system 1 is performed by operating an information delivery application provided by the information delivery system 1 and executed by the user terminal 90.

The use information acquisition unit 12 receives the first fueling information Rf1 transmitted from the vehicle 100 or the second fueling information Rf2 transmitted from the fueling device 210, and recognizes the user ID of the user U who has fueled their vehicle, the date and time of fueling, the amount of fuel fed, and the place of fueling. The use information acquisition unit 12 then records, in the user DB 31 in association with the recognized user ID, the date and time of the current biomass ethanol filling, the place thereof, and the amount of biomass ethanol fed.

The user information acquisition unit 13 accesses the user rating DB 401 of the user information server 400 to acquire the rating information Usi of the user U. The user information acquisition unit 13 then records, in the user DB 31, the rating information of the user U recognized from the rating information Usi. The social rating determination unit 14 calculates the number of times of biomass ethanol filling by the user U recorded in the user DB 31 over the past one year, and records the number of times of biomass ethanol filling in the user DB 31 as the number of times of fueling for rating.

Based on the rating information of the user U and the number of times of fueling for rating recorded in the user DB 31, the social rating determination unit 14 determines the social rating of the user U as a social rating point on a scale of 1 to 10 in accordance with the following social rating determination conditions 1 and 2.

Social rating determination condition 1: The higher the rating recognized from the rating information of the user U, the higher the social rating point the social rating determination unit 14 gives.

Social rating determination condition 2: The larger the number of times of fueling for rating, the higher the social rating point the social rating determination unit 14 gives.

Here, the credibility of the user U may be adopted as the social rating of the user U. In the case where the credibility of the user U is adopted, the social rating determination unit 14 determines the credibility of the user U using a plurality of evaluation items including the status of renewable energy use by the user U as credibility evaluation items. The social rating determination unit 14 can adopt, as the credibility evaluation items to be used together with the status of renewable energy use, the status of debt repayment by the user U, the status of payment of public utility charges, and the like in addition to the above-described crime history of the user U, rating of the user U in an SNS, and history of social service activities of the user U. Then, the social rating determination unit 14 quantifies each evaluation item and quantitatively calculates the credibility of the user U with the total of the numerical values of all the evaluation items. By quantitatively calculating the credibility of the user U in this manner, it is possible to evaluate the relative credibility of the user U.

In addition, when the social rating determination unit 14 receives, from the user terminal used by a user (rated user) who has already been given a social rating, second redetermination request information for requesting the redetermination of the social rating, the social rating determination unit 14 redetermines the social rating of the rated user. Only after confirming the reception of a second redetermination cost paid by the rated user or the like, the social rating determination unit 14 redetermines the social rating of the rated user based on the latest rating information of the rated user and the number of times of fueling for rating recorded in the user DB 31.

The social rating information output unit 15 transmits, to the communication terminal 421 of the company 420, the social rating information Uti including the social rating point of the user U. The transmission of the social rating information Uti is an example of output and delivery of the social rating information Uti. The company 420 can utilize the social rating point of the user U recognized from the social rating information Uti to, for example, distribute an advertisement for an environment-friendly product or the like to the user U having a high social rating point.

The energy supply point recognition unit 16 refers to the user DB 31 to recognize the place of biomass ethanol filling by the user U. The residence place recognition unit 17 refers to the user DB 31 to recognize the place of residence of the user U. The crime occurrence information acquisition unit 18 accesses the area information DB 411 of the area information server 410, receives the crime occurrence information Aci of each area, and records, in the area rating DB 32, the crime occurrence degree of each area recognized from the crime occurrence information Aci on a scale of 1 to 10.

The area rating determination unit 19 determines the area rating of each area on a scale of 1 to 10 in accordance with the following area rating determination conditions 1 and 2, and records the area ratings in the area rating DB 32.

Area rating determination condition 1: The lower the crime occurrence degree of the area, the higher the level of area rating the area rating determination unit 19 gives.

Area rating determination condition 2: The higher the aggregate social rating point of the area, the higher the level of area rating the area rating determination unit 19 gives.

In addition, when the area rating determination unit 19 receives, from the communication device of an administrator who manages an area (rated area) that has already been given an area rating or the communication device of a facility in the rated area, first redetermination request information for requesting the redetermination of the area rating, the area rating determination unit 19 redetermines the area rating of the rated area. Only after confirming the reception of a first redetermination cost paid by the administrator of the rated area or the facility or the like in the rated area, the area rating determination unit 19 redetermines the area rating of the rated area based on the latest aggregate social rating point of the rated area and the crime occurrence degree recorded in the area rating DB 32.

The area rating information output unit 20 transmits the area rating information Asi including the area rating to the communication terminal 421 of the company 420, the communication terminal 202 of the fueling facility 200, and the user terminal 90. The transmission of the area rating information Asi is an example of output and delivery of the area rating information Asi. The company 420 can develop a business targeting an area having a high area rating based on the area rating recognized from the area rating information Asi received by the communication terminal 421.

When the operator of the fueling facility 200 recognizes from the area rating information Asi received by the communication terminal 202 that the area rating of the area Ar1 where the fueling facility 200 is located is low, the operator can take measures to increase the safety of the fueling facility 200 by introducing security equipment such as the security camera 203. Then, when the operator of the fueling facility 200 takes measures to increase the safety, the operator transmits, to the information delivery system 1, the security enhancement information Ssi indicating that the security measures have been enhanced. When receiving the security enhancement information Ssi, the area rating determination unit 19 redetermines the area rating of the area Ar1 in accordance with the details of the security enhancement recognized from the security enhancement information Ssi, and records the area rating in the area rating DB 32.

In addition, the operator of the fueling facility 200 can transmit the first redetermination request information to the information delivery system 1 through the communication terminal 202 and pay the first redetermination cost so as to cause the area rating determination unit 19 to execute the redetermination of the area rating of the area Ar1.

In addition, the user U can check the level of the area rating displayed on a display unit 91 of the user terminal 90 based on the area rating information Asi received by the user terminal 90 so as to take measures, e.g. avoid moving to an area having a low area rating.

From the company 420, the fueling facility 200, and the user U to which the area rating information Asi has been transmitted, the information delivery consideration acquisition unit 21 acquires a consideration for the information delivery. The information delivery consideration acquisition unit 21 acquires a consideration for the information delivery by cash, virtual currency, a token available for product purchase or service use, or the like. In addition, the information delivery consideration acquisition unit 21 executes processing such as reception of the first redetermination cost and the second redetermination cost and acquisition of the considerations of the first to fourth charge amounts (described later) set by the charge amount setting unit 25. The information delivery consideration management unit 22 uses a part of the consideration for the information delivery for a biomass ethanol business, an area security business, or the like, to support the spread of biomass ethanol and the improvement of the area safety.

When receiving setting information of a destination transmitted from the user terminal 90, the route determination unit 23 determines a route from the place of departure to the destination with reference to the area rating of the area through which the vehicle passes. FIG. 1 depicts an example in which the route Rt to the destination P3 is determined with the location P2 of the home 300 of the user U in the predetermined area Ar2 as the place of departure. In this case, the route determination unit 23 determines the route Rt so as to avoid passage through the predetermined area Ar3 having a low area rating.

When receiving ride-sharing vehicle request information transmitted from the user terminal 90 for requesting the dispatch of a ride-sharing vehicle, the ride-sharing vehicle dispatch unit 24 requests the ride-sharing management server 430 to dispatch the ride-sharing vehicle 500 in accordance with the following vehicle dispatch conditions 1 and 2.

Vehicle dispatch condition 1: The ride-sharing vehicle dispatch unit 24 invites the dispatch requester to get in the ride-sharing vehicle 500 in an area Ar4 having an area rating equal to or higher than a predetermined level (e.g. level 7 or higher).

Vehicle dispatch condition 2: In a case where the ride-sharing management server 430 distinctively manages ride-sharing vehicles that use biomass fuel such as biomass ethanol and ride-sharing vehicles that use an energy source other than biomass fuel, a ride-sharing vehicle that uses biomass ethanol is dispatched to the user U whose social rating is high in preference to users whose social rating is low.

The vehicle dispatch condition 1 is applied to invite the user to get in a ride-sharing vehicle in an area having a high area rating, whereby it is possible to increase the user's comfort when they use the ride-sharing vehicle. In addition, the vehicle dispatch condition 2 is applied to dispatch a ride-sharing vehicle that uses biomass ethanol preferentially to a user who frequently fills their vehicle with biomass ethanol and thus is considered to be environmentally conscious, whereby it is possible to contribute to the improvement of environmental consciousness of the user.

The charge amount setting unit 25 sets a charge amount in accordance with the following charging conditions 1 to 4 with respect to the above-described processing by the social rating information output unit 15, the area rating information output unit 20, the route determination unit 23, and the ride-sharing vehicle dispatch unit 24. The configuration for executing processing under the charging condition 1 corresponds to a first charge amount setting unit according to the present invention, and the configuration for executing processing under the charging condition 2 corresponds to a second charge amount setting unit according to the present invention. The configuration for executing processing under the charging condition 3 corresponds to a third charge amount setting unit according to the present invention, and the configuration for executing processing under the charging condition 4 corresponds to a fourth charge amount setting unit according to the present invention.

Charging condition 1: The charge amount setting unit 25 sets, for provision of a first service that uses the area rating determined by the area rating determination unit 19, a first charge amount that depends on what the first service offers. Here, the first service includes the above-described transmission of the area rating information Asi by the area rating information output unit 20, delivery of information on the route to the destination determined by the route determination unit 23 with reference to area information, preparation of the riding point for a ride-sharing vehicle by the ride-sharing vehicle dispatch unit 24 with reference to the area rating, and the like. The charge amount setting unit 25 sets no charge or a low first charge amount for the transmission of the area rating information Asi, and sets a higher first charge amount for the preparation of the riding point for a ride-sharing vehicle than for the transmission of the area rating information Asi.

Charging condition 2: The charge amount setting unit 25 sets a second charge amount for the administrator of an area (rating-output area) for which the area rating has been determined by the area rating determination unit 19 and the area rating information Asi has been output by the area rating information output unit 20 or a facility in the rating-output area in accordance with the level of the area rating of the rating-output area. The higher the area rating, the greater the benefit the rating-output area seems to gain through the transmission of the area rating information Asi; therefore, the higher the area rating of the rating-output area, the higher the second charge amount the charge amount setting unit 25 sets.

Charging condition 3: The charge amount setting unit 25 sets, for provision of a second service that uses the social rating determined by the social rating determination unit 14, a third charge amount that depends on what the second service offers. Here, the second service includes the above-described transmission of the social rating information Uti by the social rating information output unit 15, dispatch of a ride-sharing vehicle that uses biomass fuel by the ride-sharing vehicle dispatch unit 24 with reference to the social rating, and the like. The charge amount setting unit 25 sets no charge or a low third charge amount for the transmission of the social rating information Uti, and sets a higher third charge amount for the dispatch of a ride-sharing vehicle than for the transmission of the social rating information Uti.

Charging condition 4: The charge amount setting unit 25 sets a fourth charge amount for a user (rating-output user) for which the social rating has been determined by the social rating determination unit 14 and the social rating information Uti has been output by the social rating information output unit 15 in accordance with the level of the social rating of the rating-output user. The higher the social rating, the greater the benefit the rating-output user seems to gain through the transmission of the social rating information Uti. Therefore, the higher the social rating of the rating-output user, the higher the fourth charge amount the charge amount setting unit 25 sets.

[3. Process of Determining Social Rating]

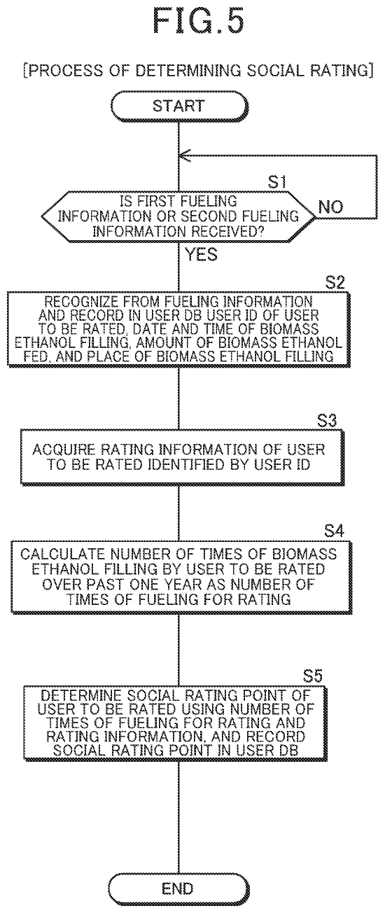

With reference to the flowchart illustrated in FIG. 5, a procedure for the process of determining the social rating of the user that is executed by the information delivery system 1 in the situation illustrated in FIG. 1 will be described.

In step S1 of FIG. 5, the use information acquisition unit 12 receives the first fueling information Rf1 transmitted from the vehicle 100 or the second fueling information Rf2 transmitted from the fueling device 210. Next, in step S2, the use information acquisition unit 12 recognizes, from the first fueling information Rf1 or the second fueling information Rf2, the user ID of the user U who has filled their vehicle with biomass ethanol, the date and time of biomass ethanol filling, the amount of biomass ethanol fed, and the place of biomass ethanol filling, and records the date and time of biomass ethanol filling, the amount of biomass ethanol fed, and the place of biomass ethanol filling in the user DB 31 in association with the user ID.

Next, in step S3, the user information acquisition unit 13 acquires the rating information of the user U identified by the user ID by accessing the user rating DB 401 of the user information server 400 and receiving the rating information Usi of the user U, and records the rating information in the user DB 31. Next, in step S4, the social rating determination unit 14 refers to the user DB 31 to calculate the number of times of biomass ethanol filling by the user U over the past one year as the number of times of fueling for rating, and records the number of times of fueling for rating in the user DB 31.

Then, in step S5, the social rating determination unit 14 determines the social rating of the user U on a scale of 1 to 10 based on the rating information of the user U and the number of times of fueling for rating recorded in the user DB 31 in accordance with the social rating determination condition 1 and the social rating determination condition 2, and records the social rating in the user DB 31.

[4. Process of Determining Area Rating]

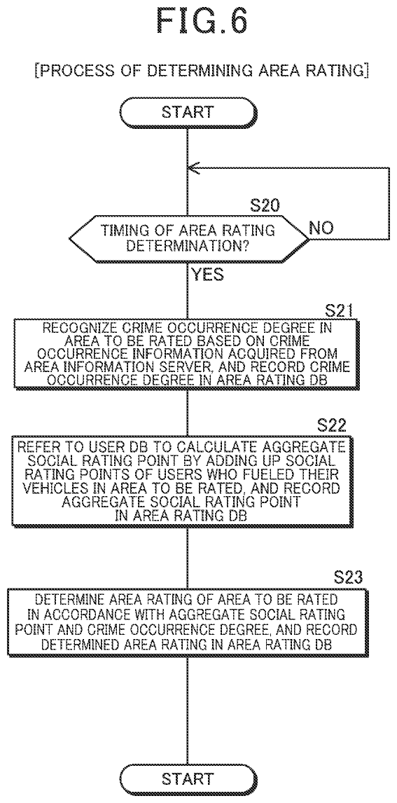

With reference to the flowchart illustrated in FIG. 6, a procedure for the process of determining the area rating of a predetermined area that is executed by the information delivery system 1 in the situation illustrated in FIG. 1 will be described. The information delivery system 1 executes the process indicated by the flowchart illustrated in FIG. 6 for each area to determine the area rating of each area. Hereinafter, the area to be given an area rating is referred to as the area to be rated.

In step S20 of FIG. 6, the area rating determination unit 19 advances the process to step S21 at the timing of area rating determination. The timing of area rating determination is set to, for example, the first day of each month. Next, in step S21, the crime occurrence information acquisition unit 18 accesses the area information DB 411 of the area information server 410 and receives the crime occurrence information Aci of the area to be rated, thereby recognizing the crime occurrence degree in the area to be rated and recording the crime occurrence degree in the area rating DB 32.

Next, in step S22, the area rating determination unit 19 refers to the user DB 31 to calculate an aggregate social rating point by adding up the social rating points of the users U who fueled their vehicles in the area to be rated, and records the aggregate social rating point in the area rating DB 32. Then, in step S23, the area rating determination unit 19 determines the area rating of the area to be rated on a scale of 1 to 10 in accordance with the area rating determination condition 1 and the area rating determination condition 2 based on the aggregate social rating point and the crime occurrence degree of the area to be rated, and records the area rating in the area rating DB 32.

### 5. Other Embodiments

In the above embodiment, biomass ethanol is shown as an example of renewable energy, and information on the supply of biomass ethanol is shown as information on the use of renewable energy, but another type of biomass fuel such as biodiesel may be used. In addition, renewable energy also includes electric power supplied by power generation from wind power, hydraulic power, geothermal power, sunlight, and the like.

In the above embodiment, fuel is supplied to the vehicle 100, but fuel or electric power may be supplied not only to vehicles but also to generators, lawn mowers, ships, and the like.

In the above embodiment, the area rating of a predetermined area is determined by the area rating determination unit 19, and area rating information including the area rating of the predetermined area is output by the area rating information output unit 20. However, the area rating determination unit 19 and the area rating information output unit 20 may be omitted.

In the above embodiment, the information delivery consideration acquisition unit 21 and the information delivery consideration management unit 22 are provided so as to use a part of the consideration for information delivery for a predetermined business. However, the information delivery consideration management unit 22 may be omitted so that the consideration for information delivery is not used for a predetermined business.

In the above embodiment, the area rating information of the area Ar1 where the fueling facility 200 is located is delivered by the area rating information output unit 20 to the fueling facility 200 that supplies biomass ethanol. Then, the area rating determination unit 19 updates the area rating of the area Ar1 when receiving security enhancement information related to the fueling facility 200. However, such delivery of area rating information to the fueling facility 200 and update of the area rating in response to the security enhancement in the fueling facility 200 may not be performed.

In the above embodiment, the social rating determination unit 14 determines the social rating of the user based on the number of times of biomass ethanol filling by the user over a predetermined evaluation period. However, the social rating of the user may be determined based on the amount of biomass ethanol put by the user in their vehicle over a predetermined evaluation period.

In the above embodiment, the route determination unit 23 is provided so as to determine a route to the destination with reference to the area rating determined by the area rating determination unit 19. However, the route determination unit 23 may be omitted.

In the above embodiment, the ride-sharing vehicle dispatch unit 24 is provided so as to dispatch a ride-sharing vehicle in accordance with the vehicle dispatch condition 1 and the vehicle dispatch condition 2 with reference to the social rating of the user determined by the social rating determination unit 14. However, the ride-sharing vehicle dispatch unit 24 may be omitted.

Note that FIG. 2 is a schematic diagram illustrating the functional configurations of the information delivery system 1 classified according to main processes in order to facilitate understanding of the present invention, and the information delivery system 1 may be configured with other classifications. In addition, the processing of each component may be executed by one hardware unit or may be executed by a plurality of hardware units. In addition, the processing of each component may be executed by one program or may be executed by a plurality of programs.

### 6. Configurations Supported by Above Embodiment

The above embodiment is a specific example of the following configurations.

(Item 1) An information delivery system comprising: a use information acquisition unit that acquires information on use of renewable energy by a user; a user information acquisition unit that acquires user information including information about evaluation of the user; a social rating determination unit that determines a social rating of the user based on the information on use and the user information; and a social rating information output unit that outputs social rating information including the social rating of the user determined by the social rating determination unit.

According to the information delivery system of item 1, the social rating determination unit determines the social rating of the user based on information on the use of renewable energy by the user and user information including information about the evaluation of the user. Here, because renewable energy produces lower carbon dioxide emissions than fossil fuel, it is estimated that users of renewable energy are highly aware of environmental burdens. Then, users who are highly aware of environmental burdens can be regarded as having high social morals. Therefore, by using information on the use of renewable energy together with user information, the social rating of the user is expected to be more objectively determined. Then, by outputting social rating information from the social rating information output unit, it is possible to deliver useful information based on information on the use of renewable energy.

(Item 2) The information delivery system according to item 1, comprising: an energy supply point recognition unit that recognizes an energy supply point that is a point where the renewable energy is supplied to the user; an area rating determination unit that determines an area rating of a predetermined area including the energy supply point based on the social rating of the user determined by the social rating determination unit; and an area rating information output unit that outputs area rating information including the area rating of the predetermined area determined by the area rating determination unit.

According to the information delivery system of item 2, the area rating of the predetermined area in which renewable energy has been supplied to the user can be determined based on the social rating of the user.

(Item 3) The information delivery system according to item 1, comprising: a residence place recognition unit that recognizes a place of residence of the user; an area rating determination unit that determines an area rating of a predetermined area including the place of residence based on the social rating of the user determined by the social rating determination unit; and an area rating information output unit that outputs area rating information including the area rating of the predetermined area determined by the area rating determination unit.

According to the information delivery system of item 3, the area rating of the predetermined area where the user lives can be determined based on the social rating of the user.

(Item 4) The information delivery system according to item 2 or 3, comprising a crime occurrence information acquisition unit that acquires crime occurrence information in the predetermined area, wherein the area rating determination unit determines the area rating of the predetermined area based on the crime occurrence information.

According to the information delivery system of item 4, the reliability of area rating determination for the predetermined area can be enhanced based on the crime occurrence information in the predetermined area.

(Item 5) The information delivery system according to any one of items 2 to 4, wherein the area rating information output unit transmits the area rating information to a communication device of a renewable energy supply facility located in the predetermined area, and when the area rating determination unit receives security enhancement information related to the renewable energy supply facility from the communication device of the renewable energy supply facility, the area rating determination unit updates the area rating of the predetermined area based on the security enhancement information.

According to the information delivery system of item 5, by enhancing the security equipment of the renewable energy supply facility, it is possible to contribute to the improvement of security in the predetermined area where the supply facility is located.

(Item 6) The information delivery system according to any one of items 2 to 4, comprising a route determination unit that acquires setting information of a destination, and determines a route from a predetermined place of departure to the destination with reference to the area rating of the predetermined area determined by the area rating determination unit.

According to the information delivery system of item 6, it is possible to determine a route that increases the safety of passage of the user.

(Item 7) The information delivery system according to any one of items 2 to 6, comprising a ride-sharing vehicle dispatch unit that acquires ride-sharing vehicle request information for requesting dispatch of a ride-sharing vehicle, and executes a process of dispatching a ride-sharing vehicle to invite a requester who has requested dispatch of a ride-sharing vehicle using the ride-sharing vehicle request information to get in a ride-sharing vehicle in the predetermined area having an area rating determined by the area rating determination unit equal to or higher than a predetermined level.

According to the information delivery system of item 7, it is possible to invite the requester to get in a ride-sharing vehicle in the predetermined area having a high area rating.

(Item 8) The information delivery system according to any one of items 1 to 7, comprising a ride-sharing vehicle dispatch unit that acquires ride-sharing vehicle request information for requesting dispatch of a ride-sharing vehicle, and executes a process of distinctively dispatching a ride-sharing vehicle that uses renewable energy and a ride-sharing vehicle that uses energy other than renewable energy to dispatch a ride-sharing vehicle that uses renewable energy to the user whose social rating determined by the social rating determination unit is high in preference to the user whose social rating determined by the social rating determination unit is low.

According to the information delivery system of item 8, by dispatching a ride-sharing vehicle that uses renewable energy preferentially to a user who uses renewable energy and thus is considered to be environmentally conscious, it is possible to contribute to the improvement of environmental consciousness of the user.

(Item 9) The information delivery system according to any one of items 1 to 8, wherein the information on use of renewable energy is information on supply of biomass fuel to the user.

According to the information delivery system of item 9, it is possible to give a user who uses biomass fuel, which is renewable energy, a social rating that is based on the status of biomass fuel use.

(Item 10) The information delivery system according to any one of items 2 to 7, comprising a first charge amount setting unit that sets, for provision of a first service that uses the area rating of the predetermined area determined by the area rating determination unit, a first charge amount that depends on what the first service offers.

According to the information delivery system of item 10, by setting the first charge amount in accordance with what the first service that uses the area rating offers, it is possible to appropriately collect a consideration for the delivery of area rating information.

(Item 11) The information delivery system according to any one of items 2 to 7 and 10, comprising a second charge amount setting unit that sets a second charge amount for an administrator of a rating-output area or a facility in the rating-output area in accordance with a level of the area rating of the rating-output area, the rating-output area being the predetermined area for which the area rating has been determined by the area rating determination unit and the area rating information has been output by the area rating information output unit.

According to the information delivery system of item 11, the second charge amount for the administrator of the rating-output area, the area rating information of which has been output, or the facility in the rating-output area can be set in accordance with how much benefit the rating-output area can gain through the output of the area rating information.

(Item 12) The information delivery system according to any one of items 2 to 7, 10, and 11, wherein when the area rating determination unit receives first redetermination request information for requesting redetermination of the area rating from an administrator of a rated area or a communication device of a facility in the rated area, the rated area being the predetermined area that has been given the area rating, the area rating determination unit redetermines the area rating of the rated area only after a first redetermination cost is received.

According to the information delivery system of item 12, when the area rating of the rated area is considered to have increased, the administrator of the rated area or the facility in the rated area can cause the area rating of the rated area to be redetermined by payment of the first redetermination cost.

(Item 13) The information delivery system according to any one of items 1 to 12, comprising a third charge amount setting unit that sets, for provision of a second service that uses the social rating of the user determined by the social rating determination unit, a third charge amount that depends on what the second service offers.

According to the information delivery system of item 13, by setting the third charge amount in accordance with what the second service that uses the social rating offers, it is possible to appropriately collect a consideration for the delivery of social rating information.

(Item 14) The information delivery system according to any one of items 1 to 13, comprising a fourth charge amount setting unit that sets a fourth charge amount for a rating-output user in accordance with a level of the social rating of the rating-output user, the rating-output user being the user for which the social rating has been determined by the social rating determination unit and the social rating information has been output by the social rating information output unit.

According to the information delivery system of item 14, the fourth charge amount for the rating-output user, whose social rating information has been output, can be set in accordance with how much benefit the rating-output user can gain through the output of the social rating information.

(Item 15) The information delivery system according to any one of items 1 to 14, wherein when the social rating determination unit receives second redetermination request information for requesting redetermination of the social rating from a communication device of a rated user, the rated user being the user who has been given the social rating, the social rating determination unit redetermines the social rating of the rated user only after a second redetermination cost is received.

According to the information delivery system of item 15, when the rated user considers that their social rating has increased, the rated user can pay the second redetermination cost to cause the social rating to be redetermined.

(Item 16) An information delivery system comprising: a use information acquisition unit that executes a use information acquisition process of acquiring information on use of renewable energy by a user; a user information acquisition unit that executes a user information acquisition process of acquiring user information including information about evaluation of the user; a social rating determination unit that determines a social rating of the user based on the information on use and the user information; and a social rating information output unit that executes a social rating information output process of outputting social rating information including the social rating of the user determined by the social rating determination unit.

According to the information delivery system of item 16, as in the case of the information delivery system of item 1, by using information on the use of renewable energy together with user information, the social rating of the user is expected to be more objectively determined. Then, by outputting social rating information from the social rating information output unit, it is possible to deliver useful information based on information on the use of renewable energy.

(Item 17) A method for information delivery that is executed by a computer, the method comprising: a use information acquisition step of acquiring information on use of renewable energy by a user; a user information acquisition step of acquiring user information including information about evaluation of the user; a social rating determination step of determining a social rating of the user based on the information on use and the user information; and a social rating information output step of outputting social rating information including the social rating of the user determined in the social rating determination step.

According to the method for information delivery of item 17, as in the case of the information delivery system of item 1, by using information on the use of renewable energy together with user information, the social rating of the user is expected to be more objectively determined. Then, by outputting social rating information in the social rating information output step, it is possible to deliver useful information based on information on the use of renewable energy.

### REFERENCE SIGNS LIST

1 information delivery system
10 CPU
11 registration unit
12 use information acquisition unit
13 user information acquisition unit
14 social rating determination unit
15 social rating information output unit
16 energy supply point recognition unit
17 residence place recognition unit
18 crime occurrence information acquisition unit
19 area rating determination unit
20 area rating information output unit
21 information delivery consideration acquisition unit
22 information delivery consideration management unit
23 route determination unit
24 ride-sharing vehicle dispatch unit
25 charge amount setting unit
30 memory
31 user DB
32 area rating DB
33 control program
40 communication unit
90 user terminal
100 vehicle
200 fueling facility
210 fueling device
300 user's home
400 user information server
410 area information server
420 company
430 ride-sharing management server
500 ride-sharing vehicle
900 communication network
U user
Ar1 to Ar4 predetermined area

1. An information delivery system comprising:
a use information acquisition unit that acquires information on use of renewable energy by a user;
a user information acquisition unit that acquires user information including information about evaluation of the user;
a social rating determination unit that determines a social rating of the user based on the information on use and the user information;
a social rating information output unit that outputs social rating information including the social rating of the user determined by the social rating determination unit;
an area rating determination unit that determines an area rating of a predetermined area based on the social rating of the user determined by the social rating determination unit; and
an area rating information output unit that outputs area rating information including the area rating of the predetermined area determined by the area rating determination unit.

2. The information delivery system according to claim 1, comprising
an energy supply point recognition unit that recognizes an energy supply point that is a point where the renewable energy is supplied to the user, wherein
the area rating determination unit determines an area rating of the predetermined area including the energy supply point.

3. The information delivery system according to claim 1, comprising
a residence place recognition unit that recognizes a place of residence of the user, wherein
the area rating determination unit determines an area rating of the predetermined area including the place of residence.

4. The information delivery system according to claim 1, comprising
a come occurrence information acquisition unit that acquires crime occurrence information in the predetermined area, wherein
the area rating determination unit determines the area rating of the predetermined area based on the crime occurrence information.

5. The information delivery system according to claim 1, wherein
the area rating information output unit transmits the area rating information to a communication device of a renewable energy supply facility located in the predetermined area, and
when the area rating determination unit receives security enhancement information related to the renewable energy supply facility from the communication device of the renewable energy supply facility, the area rating determination unit updates the area rating of the predetermined area based on the security enhancement information.

6. The information delivery system according to claim 1, comprising
a route determination unit that acquires setting information of a destination, and determines a route from a predetermined place of departure to the destination with reference to the area rating of the predetermined area determined by the area rating determination unit.

7. The information delivery system according to claim 1, comprising
a ride-sharing vehicle dispatch unit that acquires ride-sharing vehicle request information for requesting dispatch of a ride-sharing vehicle, and executes a process of dispatching a ride-sharing vehicle to invite a requester who has requested dispatch of a ride-sharing vehicle using the ride-sharing vehicle request information to get in a ride-sharing vehicle in the predetermined area having an area rating determined by the area rating determination unit equal to or higher than a predetermined level.

8. The information delivery system according to claim 1, comprising
a first charge amount setting unit that sets, for provision of a first service that uses the area rating of the predetermined area determined by the area rating determination unit, a first charge amount that depends on what the first service offers.

9. The information delivery system according to claim 1, comprising
a second charge amount setting unit that sets a second charge amount or an administrator of a rating-output area or a facility in the rating-output area in accordance with a level of the area rating of the rating-output area, the rating-output area being the predetermined area for which the area rating has been determined by the area rating determination unit and the area rating information has been output by the area rating information output unit.

10. The information delivery system according to claim 1, wherein
when the area rating determination unit receives first redetermination request information for requesting redetermination of the area rating from an administrator of a rated area or a communication device of a facility in the rated area, the rated area being the predetermined area that has been given the area rating, the area rating determination unit redetermines the area rating of the rated area only after a first redetermination cost is received.

11. An information delivery system comprising:
a use information acquisition unit that acquires information on use of renewable energy by a user;
a user information acquisition unit that acquires user information including information about evaluation of the user;
a social rating determination unit that determines a social rating of the user based on the information on use and the user information;
a social rating information output unit that outputs social rating information including the social rating of the user determined by the social rating determination unit; and
a ride-sharing vehicle dispatch unit that acquires ride-sharing vehicle request information for requesting dispatch of a ride-sharing vehicle, and executes a process of distinctively dispatching a ride-sharing vehicle that uses renewable energy and a ride-sharing vehicle that uses energy other than renewable energy to dispatch a ride-sharing vehicle that uses renewable energy to the user whose social rating determined by the social rating determination unit is high in preference to the user whose social rating determined by the social rating determination unit is low.

12. The information delivery system according to claim 1, wherein
the information on use of renewable energy is information on supply of biomass fuel to the user.

13. The information delivery system according to claim 1, comprising
a third charge amount setting unit that sets, for provision of a second service that uses the social rating of the user determined by the social rating determination unit, a third charge amount that depends on what the second service offers.

14. The information delivery system according to claim 1, comprising
a fourth charge amount setting unit that sets a fourth charge amount for a rating-output user in accordance with a level of the social rating of the rating-output user, the rating-output user being the user for which the social rating has been determined by the social rating determination unit and the social rating information has been output by the social rating information output unit.

15. The information delivery system according to claim 1, wherein
when the social rating determination unit receives second redetermination request information for requesting redetermination of the social rating from a communication device of a rated user, the rated user being the user who has been given the social rating, the social rating determination unit redetermines the social rating of the rated user only after a second redetermination cost is received.

16. A method for information delivery that is executed by a computer, the method comprising:
a use information acquisition step of acquiring information on use of renewable energy by a user;
a user information acquisition step of acquiring user information including information about evaluation of the user;
a social rating determination step of determining a social rating of the user based on the information on use and the user information;
a social rating information output step of outputting social rating information including the social rating of the user determined in the social rating determination step;
an area rating determination step of determining an area rating of a predetermined area based on the social rating of the user determined in the social rating determination step; and
an area rating information output step of outputting area rating information including the area rating of the predetermined area determined in the area rating determination step.

17. (canceled)
